(19) United States
(12) Patent Application Publication
(10) Pub. No.: US 2016/0339402 A1
(43) Pub. Date: Nov. 24, 2016

(54) DUAL-DIRECTION MIXING IMPELLER

(71) Applicant: National Oilwell Varco, L.P., Houston, TX (US)

(72) Inventors: Eric Edward Antonio Janz, Centerville, OH (US); Kevin J. Myers, Oakwood, OH (US)

(21) Appl. No.: 14/718,860

(22) Filed: May 21, 2015

(51) Int. Cl. B01F 7/00

(52) U.S. Cl. CPC B01F 7/00341

(57) ABSTRACT

An impeller, which may be a dual-direction mixing impeller, may include a hub and a blade extending from the hub, the blade having a substantially flat root portion and a twisted outer portion, the blade terminating at the twisted outer portion.

### TECHNICAL FIELD

This disclosure relates to impellers and, more particularly, to impellers for mixing and blending fluids within vessels.

### BACKGROUND

Mixing or blending a fluid or fluids within a vessel typically is accomplished using one or more impellers mounted on a shaft that is driven by a motor external to the vessel. The impeller may be oriented within the vessel so that the shaft is substantially vertical, and the motor may be mounted on the lid of the vessel or suspended above the vessel. Depending on the size of the vessel, a series of impellers may be mounted on a single shaft and spaced along its length within the vessel. The impellers typically have two or more blades extending radially from and spaced evenly about a hub mounted on the shaft. The blades have a twisted contour that, when rotated on the shaft, impart a movement to the fluids to be mixed or blended.

Mixing or blending fluids in transitional flow is difficult because rotation of bladed impellers on a vertical shaft produces fluid movement in the radial and tangential directions, rather than the desired axial or vertical direction, which would result in rapid top-to-bottom fluid movement. Instead, the radial and tangential fluid movement leads to limited fluid flow between adjacent impellers, effectively isolating each impeller and leading to prolonged times to achieve desired blending of fluids within the vessel.

Efforts to overcome these disadvantages include the use of an impeller in the form of a helical ribbon having a diameter only slightly less than that of the inside diameter of the vessel. Such helical ribbons typically extend the entire height of the vessel. While such helical ribbon impellers may produce the desired axial flow and rapid fluid mixing and blending, the impeller blade geometry is complex and expensive to fabricate. It is also costly to size such helical ribbon impellers to have close tolerances to avoid undesired contact between the outer edge of a helical ribbon impeller and the inner surface of the vessel in which it is mounted.

Another solution involves the use of multiple, relatively inexpensive impellers, each having a pitched blade, with a large number of closely spaced impellers mounted along the drive shaft and spaced along the vessel height to ensure adequate flow between adjacent impellers. A third approach utilizes multiple impellers along the drive shaft and spaced along the vessel height using impeller blades shaped to provide fluid flow that mimics the fluid flow produced by a helical ribbon impeller, with upward axial flow produced by a portion of the impeller blade, and downward axial flow produced by a remainder of the impeller blade. Such impellers, called counterflow impellers, actually produce complex fluid flow patterns within a vessel. Rather than producing a simple upflow and downflow, such counterflow impellers actually produce as many as three or four flow regions within a vessel, which leads to performance losses and inefficiencies due to limited flow between adjacent impellers.

Accordingly, there is a need for a counterflow impeller that produces a simple fluid upflow and fluid downflow within a vessel that improves blending efficiency.

### SUMMARY

In one embodiment, the disclosed dual-direction mixing impeller may include a hub and a blade extending from the hub, the blade having a substantially flat root portion and a twisted outer portion, the blade terminating at the twisted outer portion.

In another embodiment, a mixing impeller may include a hub having a central axis of rotation, and a pair of blades extending radially from opposing sides of the hub, each of the blades having a substantially flat root portion and a twisted outer portion, the blade terminating at the twisted outer portion.

In yet another embodiment, a method of making a mixing impeller may include forming a hub having a central axis of rotation, forming a pair of blades, each of the blades having a substantially flat root portion, a twisted outer portion, and terminating at the twisted outer portion, wherein the twisted outer portion is attached directly to the root portion, and attaching the pair of blades to the hub, the blades extending radially from opposing sides of the hub, wherein each of the pair of blades is attached at a base of the root portion to the hub.

Other objects and advantages of the disclosed mixing impeller will be apparent from the following description, the accompanying drawings, and the appended claims.

### BRIEF DESCRIPTION OF THE DRAWINGS

FIG. 1 is a side elevation of a prior art impeller within a vessel;

FIG. 2 is a side elevation of the disclosed dual-direction mixing impeller mounted on a driveshaft and located within a vessel;

FIG. 3 is a perspective view of the dual-direction mixing impeller of FIG. 2;

FIG. 4 is a side elevation of the dual-direction mixing impeller of FIG. 2;

FIG. 5 is an end elevational view of the dual-direction mixing impeller of FIG. 2; and

FIG. 6 is a planform view of the dual-direction mixing impeller of FIG. 2.

### DETAILED DESCRIPTION

As shown in FIG. 1, a prior art impeller, generally designated 10, is shown mounted on a hub 12 that is attached to a shaft 14. The shaft 14 and impeller 10 are positioned within a vessel 16 containing fluids 18 to be blended or mixed. The impeller 10 is shown and described in greater detail in U.S. Pat. No. 3,365,176, the entire contents of which are incorporated herein by reference.

The impeller 10 includes a pair of blades 20, 22 that extend radially outward from the hub 12, and are attached to opposing sides of the hub. Each of the blades 20, 22 includes a flat, plate-shaped root portion 24, a twisted portion 26, and an outer flat portion 28. The outer flat portions 28 are plate-shaped. The root portions 24 of the blades 20, 22 are pitched 45° from the axis of rotation of the shaft 14 of the impeller 10, and the outer portions 28 are pitched 90° from the root portions. Typically, there are several impellers 10 spaced along the shaft 14 within the vessel 16 to promote mixing throughout the depth of the vessel.

Tests have shown that when such prior art impellers 10 rotate within the vessel 16, the root portions 24 cause fluid 18 in the vessel 16 to flow in a downward direction, indicated by arrows A, the outer portions 28 create fluid flow in an upward direction, indicated by arrows B and fluid flow adjacent the walls of the vessel 16 in a downward direction, as indicated by arrows C. While this impeller 10 produces a counterflow within the vessel 16, that is, fluid flow in both upward and a downward directions within the vessel, a disadvantage of the flow patterns created by this impeller is that three or four flow regions are produced, which leads to performance losses and inefficiencies due to limited flow between adjacent impellers on the shaft 14.

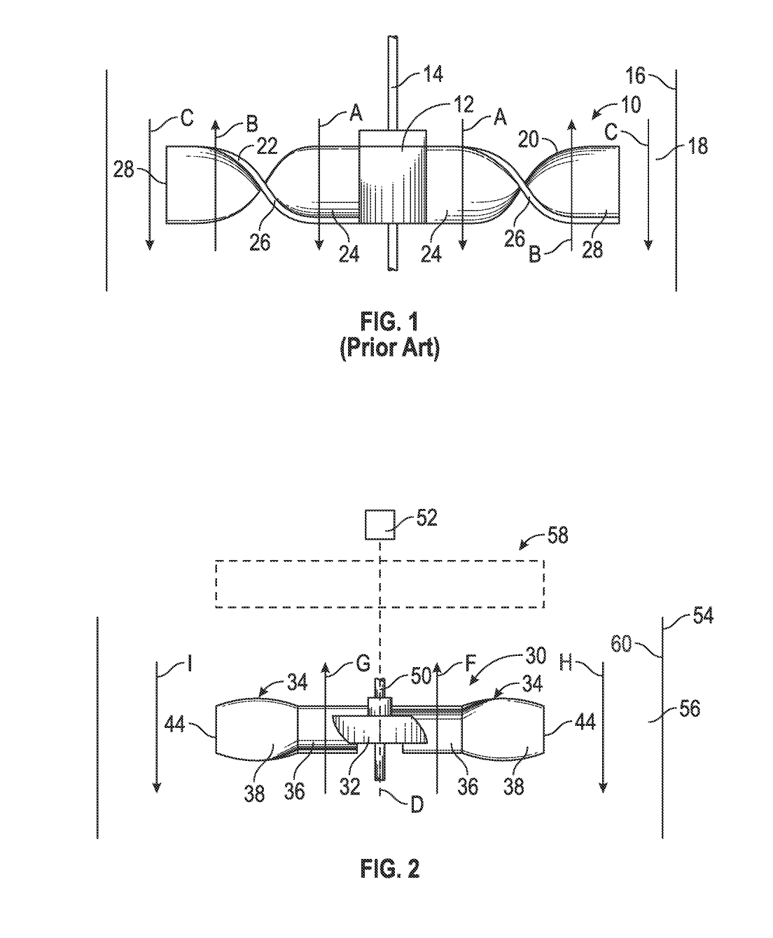

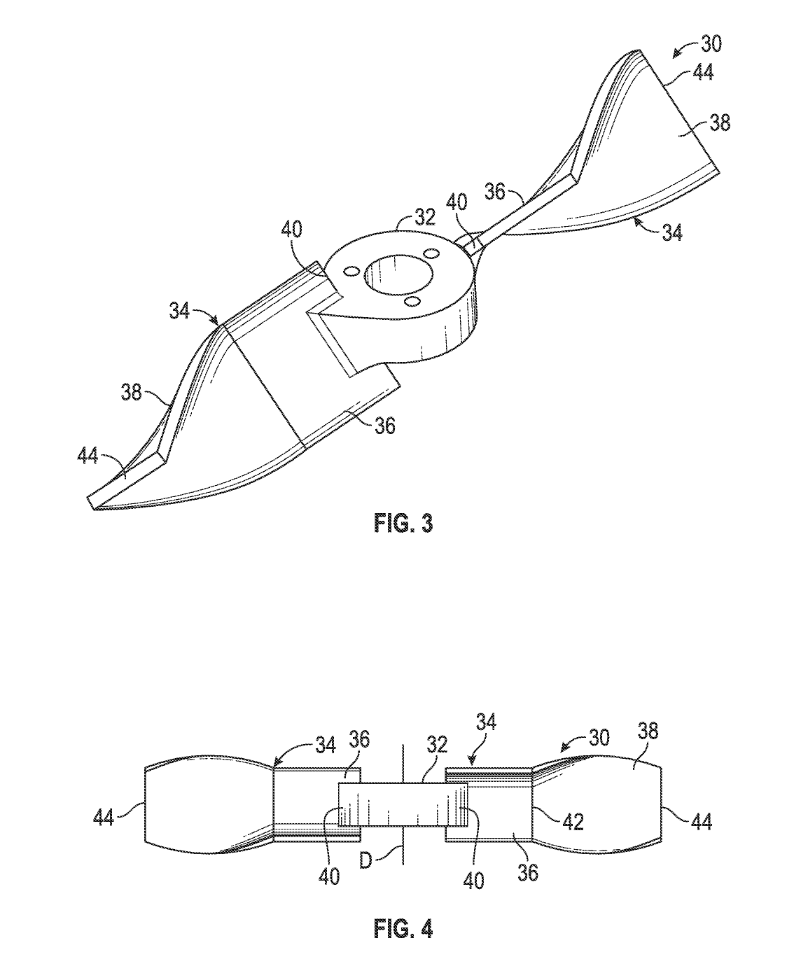

As shown in FIGS. 2, 3, 4, 5, and 6, the disclosed mixing impeller, generally designated 30, may, in certain embodiments, function as a dual-direction impeller, and may operate in the transitional flow regime (as indicated by impeller Reynolds numbers ranging from approximately 50 to approximately 1,000). The impeller 30 may include a hub 32 and at least one blade 34 extending from the hub. The blade may have a substantially flat root portion 36 and a twisted outer portion 38. The blade 34 terminates at the twisted outer portion 38. In an embodiment, the impeller 30 may include a plurality of blades 34, each of the blades extending radially from a rotational axis D of the hub 32. In one particular embodiment, the plurality of blades 34 may take the form of two blades 34, each attached to the hub 32 and extending radially from opposite sides of the hub.

In an embodiment, each blade 34 may be of constant thickness along its length. In other embodiments, the thickness of each blade 34 may vary. For example, the inner portion of each blade, such as the root portion 36, may be relatively thicker to resist higher stresses, and the twisted outer portion 38 may be relatively thinner. Also in an embodiment, each blade 34 may be symmetric about a centerline E (see FIG. 6) along its length. The chord lengths, that is, the width of the impeller blades 34 measured perpendicular to the axis E, may be constant along the lengths of the blades. In an embodiment, a ratio of the chord length to the length of the blades 34 is 1:6, or approximately 1:6.

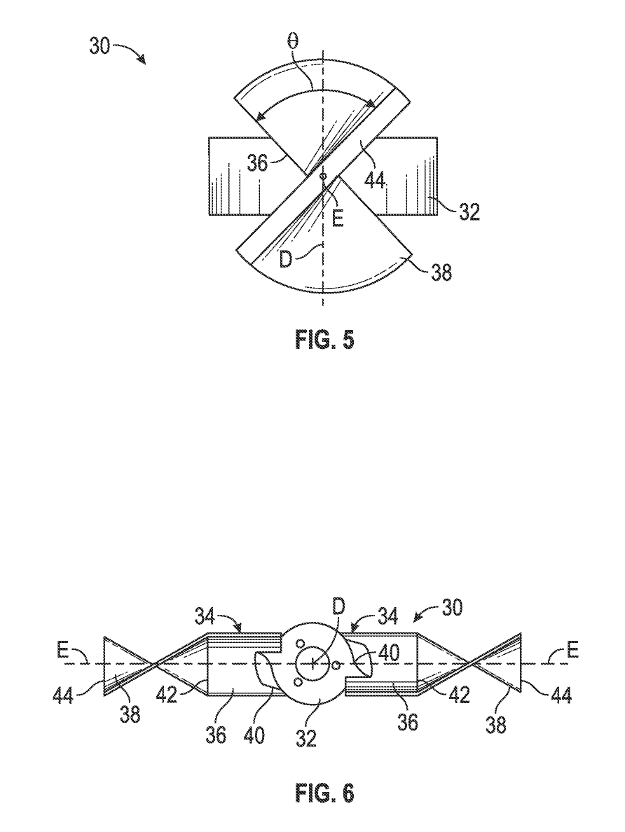

As shown in FIGS. 2-6, the blades 34 may be attached at a base 40 of their root portions 36 to the hub 32. As best shown in FIG. 5, the root portions 36 of the blades 34 may be oriented at an angle of between 30° and 45° to the axis D of rotation of the impeller 30.

As shown in FIGS. 2-6, the twisted outer portion 38 of each of the blades 34 may be attached directly to the root portions 36, as indicated by seam lines 42. In an embodiment, the root portions 36 of the blades 34 extend one-half the length of the blade, and the twisted outer portions 38 extend one-half the length of the blade. Accordingly, the entire length of the blade consists of either the root portion 36 or the twisted outer portion 38; there are no intermediate segments of the blade, and there are no segments of the blade that extend radially beyond the twisted outer portion. In an embodiment, the transition from a thicker root portion 36 to a thinner twisted outer portion 38 may occur at the seam lines 42 of the blades 34.

The shape of the twisted outer portions 38 of each of the blades 34 may take the form of a continuous twist, such as a doubly ruled hyperbolic paraboloid, or a helicoid. The twisted outer portions 38 may terminate in a tip 44. As shown in FIG. 5, the tip 44 may be oriented at an angle θ of between 90° and 135° to the root portion 36. In a particular embodiment, the outer portion 38 may terminate in the tip 44 oriented at an angle θ of approximately 90° to the root portion 36 of each blade 34. The tip 44 of each blade 34 may be squared off; that is, each tip may take the form of a radially outer edge surface that is straight and parallel to the axis D of rotation of the impeller 30. The tip 44 may be squared off to form a surface that is oriented at a right angle to the centerline E of the blade 34.

The transitional flow impeller 30 may be made by a method in which the hub 32 is formed, having a central axis of rotation D. A pair of blades 34, each of the blades having a substantially flat root portion 36, a twisted outer portion 38, and terminating at the twisted outer portion, may be formed such that the twisted outer portion is attached directly to the root portion at the seam 42. The blades 34 each may be attached to the hub 32 so that they extend radially from opposing sides of the hub, wherein each of the pair of blades may be attached at a base 40 of the root portion of the hub.

In one embodiment, each of the blades 34 may be formed from a single rectangular plate. The twisted outer portion 38 may be formed by twisting the outer portion of the rectangular plate to have a shape selected from a helicoid and a doubly ruled hyperbolic paraboloid. The blades 34 may be attached to a hub 32 by means such as welding or brazing. In an embodiment, the hub 32 and blades 34 may be made of a corrosion-resistant material selected from stainless steel, nickel alloy, aluminum alloy, and bronze.

In another embodiment, each of the blades 34 may be formed from two pieces. A flat, plate-shaped root portion 36 may be welded or brazed to a twisted outer portion 38. This construction may be desirable for blades 34 having relatively longer lengths. If such a two-piece blade 34 varies in thickness, such that the root portion 36 is thicker than the twisted outer portion 38, the weld bead (not shown) at the seam 42 may serve as a transition surface between the two components.

As shown in FIG. 2, the impeller 30 may be mounted on a shaft 50 that is attached to a drive motor 52. The impeller 30 and shaft 50 may be placed within a vessel 54 filled with a fluid or fluids 56 to be blended or mixed. In embodiments, the drive motor 52 may be mounted above the vessel 54 and attached to supporting structure (not shown), or may be mounted within the vessel and attached to the vessel to be suspended above the fluid or fluids 56 to be mixed or blended, or may be mounted on a lid or cover (not shown) for the vessel, such that the drive shaft 50 extends through the lid or cover. In embodiments, one or more additional impellers 58, which may be of similar construction to impeller 30, may be mounted on the shaft 50 above and/or below the impeller within the vessel 54.

When the drive motor 52 is actuated, the motor may rotate the shaft 50, causing the impeller 30 to rotate about the rotational axis D within the vessel 54, which in FIG. 2 may be in a counterclockwise direction. This may cause mixing or blending of the fluid or fluids 56 within the vessel. The movement of the fluid 56 within the vessel 54 is shown by arrows F, G, H, and I. Fluid flow effected by the substantially flat root portions 24 of the impeller blades 34 travels upwardly as shown by arrows F and G. The twisted outer portions 28 of the impellers 34 may cause the fluid 56 to flow downwardly adjacent the walls 60 of the vessel 54, as indicated by the direction of arrows H, I. Accordingly, the impeller 34 may enhance mixing of the fluid 56 by inducing axial flow in opposite directions in the inner (represented by arrows F, g and outer (represented by arrows H, I) sections of the impeller.

The impeller 30 may be a dual-direction mixing impeller. Rotation of the impeller 30 on the shaft 50 by motor 52 in an opposite direction (which would be clockwise) may produce fluid flow in directions opposite that shown by arrows F, G, H, and I in FIG. 2, resulting in blending and mixing of the fluid 56 in vessel 54.

This flow pattern developed is more conducive to rapid top-to-bottom mixing and blending of the fluid 56 in the vessel 54 than prior art impellers that may develop three or four flow loops, which may lead to compartmentalization of the fluid flow around each impeller and may result in slower mixing. While the system shown in FIG. 2 that utilizes impeller 30 may be particularly effective for mixing fluids 56 with moderate to high viscosity, and which may or may not have complex rheology, the impeller may be used to mix a variety of fluids across a wide range of viscosities.

The improved mixing performance of the impeller 30 may be a result of terminating the blades 34 with a squared off tip 44 at the end of the twisted outer portion 38. Further, in embodiments, the squared off tip may be perpendicular, or substantially perpendicular, to the centerline E of the blades 34. This is in contrast to prior art impellers, such as the impeller 10 shown in FIG. 1, having blades 20, 22, each of which includes an extension 28 beyond the twisted portion 26.

While the forms of apparatus and methods disclosed herein constitute preferred embodiments of the disclosed dual-direction mixing impeller, it is to be understood that the disclosure is not limited to these precise structures and methods, and that changes may be made therein without departing from the scope of the disclosure.

What is claimed is:

1. A dual-direction mixing impeller comprising:
a hub; and
a blade extending from the hub, the blade having a substantially flat root portion and a twisted outer portion, the blade terminating at the twisted outer portion.

2. The impeller of claim 1, further comprising a plurality of the blades, each of the blades extending radially from a rotational axis of the hub.

3. The impeller of claim 1, wherein the blade is selected from one of constant thickness along its length, and varying thickness along its length.

4. The impeller of claim 1, wherein the blade is symmetric about a centerline along its length.

5. The impeller of claim 1, wherein chord lengths are constant along a length of the blade.

6. The impeller of claim 5, wherein a ratio of chord length to blade length is 1:6.

7. The impeller of claim 1, wherein the blade is attached at a base of the root portion to the hub.

8. The impeller of claim 7, wherein the root portion is oriented at an angle of between 30° and 45° to an axis of rotation of the impeller.

9. The impeller of claim 8, wherein the root portion is oriented at an angle of 45° to the axis of rotation of the impeller.

10. The impeller of claim 1, wherein the twisted outer portion is attached directly to the root portion.

11. The impeller of claim 10, wherein the root portion extends one-half a length of the blade; and the twisted outer portion extends one-half the length of the blade.

12. The impeller of claim 1, wherein a shape of the twisted outer portion is selected from a helicoid and a doubly ruled hyperbolic paraboloid.

13. The impeller of claim 1, wherein the twisted outer portion terminates in a tip oriented at an angle of between 90° and 135° to the root portion.

14. The impeller of claim 13, wherein the outer portion terminates in the tip oriented at an angle of 90°.

15. The impeller of claim 14, wherein the tip is squared off.

16. The impeller of claim 15, wherein the tip is squared off at a right angle to a centerline of the blade.

17. A mixing impeller comprising:
a hub having a central axis of rotation; and
a pair of blades extending radially from opposing sides of the hub, each of the blades having a substantially flat root portion and a twisted outer portion, the blade terminating at the twisted outer portion.

18. The impeller of claim 17, wherein each of the pair of blades is attached at a base of the root portion to the hub; and the twisted outer portion is attached directly to the root portion.

19. A method of making a mixing impeller, the method comprising:
forming a hub having a central axis of rotation;
forming a pair of blades, each of the blades having a substantially flat root portion, a twisted outer portion, and terminating at the twisted outer portion, and the twisted outer portion is attached directly to the root portion; and
attaching the pair of blades to the hub, the blades extending radially from opposing sides of the hub, wherein each of the pair of blades is attached at a base of the root portion to the hub.

20. The method of claim 19, wherein forming a pair of blades comprises forming each blade of the pair of blades from a single rectangular plate; and forming each twisted outer portion by twisting the outer portion of the rectangular plate to have a shape selected from a helicoid and a doubly ruled hyperbolic paraboloid.
